(19) United States
(12) Patent Application Publication
(10) Pub. No.: US 2004/0019469 A1
(43) Pub. Date: Jan. 29, 2004

(54) Method of generating a multifidelity model of a system

(76) Inventors: Stephen J. Leary, Bristol (GB); Atul Bhaskar, Fareham (GB); Andrew J. Keane, Romsley (GB)

Correspondence Address: MANELLI DENISON & SELTER, 2000 M STREET NW SUITE 700, WASHINGTON, DC, 20036-3307, US

(21) Appl. No.: 10/608,042

(22) Filed: Jun. 30, 2003

(30) Foreign Application Priority Data
Jul. 24, 2002 (GB) 0217090.0

(51) Int. Cl. G06F 17/10

(52) U.S. Cl. 703/2

(57) ABSTRACT

A method of generating a multifidelity model of a system comprises the steps of obtaining training data from a high fidelity model of the system, providing a low fidelity model of the system, providing a kriging model to compensate for discrepancies between the high and low fidelity models, adjusting the kriging model to maximise the likelihood of the training data when the low fidelity model, compensated by the kriging model, is used to model the system, and generating a multifidelity model of the system based on the low fidelity model when compensated by the adjusted by the adjusted kriging model. The system may be a gas turbine or a part of a gas turbine for example a tail bearing housing.

### FIELD OF THE INVENTION

The present invention relates to a method of generating a multifidelity model of a system.

### BACKGROUND

High cost/high fidelity models are used in relation to many engineering design problems. For example, a typical high fidelity model might be a finite element (FE) model having a large number of elements which allow an engineering system's behaviour to be characterised to a high level of accuracy. Design optimisation of the system using the FE model may be desirable, but may also require many rounds of analysis. This can entail high computational burdens which can make the optimisation process impractical.

For this reason, more approximate or low fidelity models for systems may be sought. Such low fidelity models may be global or local. Global low fidelity models try to capture the behaviour of an objective function and/or constraints over the entire domain of interest. Local models are defined in a specific region of the design space.

A common way of tackling the problem of expensive function/model optimization is through the use of approximations to the expensive function/model. Response surface methods (see for example Myers and Montgomery, (1995)) seek polynomial approximations to the function/model. Th-e-se approximations, once constructed, define a low fidelity model which can provide a cheap means of approximating the original expensive function/model.

An approach based on kriging is described in Jones et al. (1998). Their algorithm builds a global approximation using a kriging model and then performs optimisation using this model. Another possible approximation strategy involves the use of neural networks to build a global approximation. However, both these approaches are, in effect, methods of curve fitting. They build low cost models using data points from the high cost model and do not attempt to incorporate any further information on the problem in hand.

One concern with these approaches is the level of accuracy of the resulting approximation arising from the inevitably limited quantities of training data used. As a result, there has been an interest in the use of low fidelity models to sample parameter space at points that are not sampled during expensive function/model evaluation. These low fidelity models, while being less accurate than the original model, are generally much cheaper to compute. As an example, in an FE analysis the cheap model may use a coarser mesh than the original expensive model, while during a computational fluid dynamics (CFD) analysis a panel code may replace an expensive Euler analysis. Combining a low fidelity models with a more accurate but expensive result in a useful compromise between accuracy and computational cost.

Perhaps the simplest way of utilizing low fidelity information is to consider the differences between the high and low fidelity models. Thus Watson and Gupta (1996) used a neural network to model differences between the two models and applied the approach to microwave circuit design. Their technique uses a design of experiments (DOE) methodology to identify configurations of the input variables for which to run the high fidelity model. The low fidelity model is then run at these design points, providing information on the difference between the two models. An approximation to the high fidelity model can then be constructed using the low fidelity model and an approximation to the difference.

An alternative to this approach is to model the ratio of high and low fidelity models. For example, Haftka (1991) and Chang et al. (1993) calculate the ratio and derivatives at one point in order to provide a linear approximation to the ratio at other points in the design space. The approach is applied to a wing-box model of a high speed civil transport aircraft. More recently—the approach has been applied using polynomial models to approximate the ratio. The approach, termed a “correction response surface” model, has been applied to aerodynamic drag approximation by Hutchinson et al. (1994) as well as structural problems, for example, see Vitali et al. (1999).

Recently Wang and Zhang (1997) developed a knowledge-based neural network model for microwave design. This approach included problem specific knowledge in the form of generic empirical functions inside the neural network. However, this approach has limitations applicability when empirical functions representing knowledge are unavailable.

Furthermore, a disadvantage associated with neural network-based approaches are the difficulties of identifying the optimal neural network architecture and properly training the network.

### SUMMARY OF THE INVENTION

Thus, in general terms a first aspect of the present invention provides a method of generating a multifidelity model of a system in which a kriging model is used to compensate for discrepancies between high and low fidelity models of the system.

More specifically, the first aspect of the present invention provides a method of generating a multifidelity model or a system, comprising the steps of:

(a) obtaining training data from a high fidelity model of the system;

(b) providing a low fidelity model of the system;

(c) providing a kriging model to compensate for discrepancies between the high and low fidelity models;

(d) adjusting the kriging model to maximise the likelihood of said training data when the low fidelity model, compensated by the kriging model, is used to model the system; and

(e) generating a multifidelity model of the system based on the low fidelity model when compensated by the adjusted kriging model.

Typically, each training datum comprises (i) a plurality of input parameters for the high fidelity model and (ii) corresponding one or more output parameters which result from running the high fidelity model with these input parameters. Preferably the data points are selected in order to sample “design space” representatively.

We have found that, by using a kriging model to compensate for discrepancies between the high and low fidelity models, the training of the multifidelity model can be greatly simplified compared to models based on neural networks. Furthermore, this advantage is obtainable without significantly compromising the accuracy of the model.

The kriging model may compensate for discrepancies between the high and low fidelity models by modelling the differences between the output parameters of the high fidelity model and the corresponding output parameters of the low fidelity model. Alternatively, the kriging model may compensate for discrepancies by modelling the ratios between the output parameters of the high fidelity model and the corresponding output parameters of the low fidelity model. Other compensation schemes known to the skilled person may also be adopted.

In general terms, a further aspect of the present invention provides a method of generating a multifidelity model of a system comprising providing a low fidelity model of the system which has adjustable weightings for respective input parameters to the low fidelity model, and adjusting the weightings to maximise the likelihood of training data obtained from a high fidelity model.

We have found that by using such an approach, significant characteristics of the behaviour of high fidelity models can be captured directly within the low fidelity model. This can lead to overall improvements in modelling accuracy.

More specifically, the second aspect of the present invention provides a method of generating a multifidelity model of a system, comprising the steps of:

(a) obtaining training data from a high fidelity model of the system;

(b) providing a low fidelity model of the system, the low fidelity model having adjustable weightings for respective input parameters to the low fidelity model;

(c) providing a compensation model to compensate for discrepancies between the high and low fidelity models;

(d) adjusting the compensation model and the weightings to optimise the correlation of the low fidelity model, when compensated by the compensation model, with said training data; and

(e) generating a multifidelity model of the system based on the adjusted low fidelity model when compensated by the adjusted compensation model.

For example, the weightings may comprise shifts in the values of the respective input parameters. Alternatively, or additionally, the weightings may comprise scalings in the values of the respective input parameters.

Preferably, the compensation model is a kriging model, in which case the correlation optimisation in step (d) is effectively a likelihood maximisation. In this way, advantages of the methods of both aspects of the invention may be combined. However, the compensation model may be e.g. a neural network.

Typically, the system of the methods of either of the previous aspects comprises a gas turbine or a part of a gas turbine. The models may be of stress, strain, fluid flow, thermal etc. fields.

Further aspects of the invention provide (i) computer readable program code for implementing the method of either of the previous aspects, (ii) computer readable media carrying program code for implementing the method of either of the previous aspects, and (iii) a computer system operatively configured to implement the method of either of the previous aspects.

As used herein, “computer readable media” refers to any medium or media which can be read and accessed directly by a computer. Such media include, but are not limited to: magnetic storage media such as floppy discs, hard disc storage medium and magnetic tape; optical storage media such as optical discs or CD-ROM; electrical storage media such as RAM and ROM; and hybrids of these categories such as magnetic/optical storage media.

As used herein, “a computer system” refers to any hardware means, software means and data storage means used to perform a computer-implemented method of the present invention. The minimum hardware means of such a computer system typically comprises a central processing unit (CPU), input means, output means and data storage means. The data storage means may be RAM or means for accessing computer readable media. An example of such a system is a microcomputer workstation available from e.g. Silicon Graphics Incorporated and Sun Microsystems running Unix based, Windows NT or IBM OS/2 operating systems.

For example, a computer system for implementing the method of the first aspect of the invention may comprise:

a data storage device or devices for storing (a) training data obtained from a high fidelity model of the system, (b) a low fidelity model of the system, and (c) a kriging model to compensate for discrepancies between the high and low fidelity models, and

a processor for (a) adjusting the kriging model to maximise the likelihood of said training data when the low fidelity model, compensated by the kriging model, is used to model the system, and (b) generating a multifidelity model of the system based on the low fidelity model when compensated by the adjusted kriging model.

A computer system for implementing the method of the second aspect of the invention may comprise:

a data storage device or devices for storing (a) training data obtained from a high fidelity model of the system, (b) a low fidelity model of the system, the low fidelity model having adjustable weightings for respective input parameters to the low fidelity model, and (c) a compensation model to compensate for discrepancies between the high and low fidelity models, and

a processor for (a) adjusting the compensation model and the weightings to optimise the correlation of the low fidelity model, when compensated by the compensation model, with said training data, and (b) generating a multifidelity model of the system based on the adjusted low fidelity model when compensated by the adjusted compensation model.

Further aspects of the invention provide (i) computer readable program code for implementing a multifidelity model generated using the method of any one of the previous aspects, (ii) computer readable media carrying program code for implementing a muitifidelity model generated using the method of any one of the previous aspects, and (iii) a computer system operatively configured to implement a multifidelity model generated using the method of any one of the previous aspects.

### BRIEF DESCRIPTION OF THE DRAWINGS

Examples of the present invention will now be described in more detail with reference to the accompanying drawings, in which:

FIG. 1 shows the overall architecture of a multifidelity model based on a neural network and a low fidelity model,

FIG. 2 shows in more detail the multifidelity model of FIG. 1,

FIG. 3 shows the overall architecture of a multifidelity model based on a kriging model and a low fidelity model,

FIG. 4 shows schematically an elastic beam structure used in Example 1,

FIG. 5 shows schematically two two-dimensional problems (Problems A and B) based on the structure of FIG. 4,

FIG. 6 shows schematically a four-dimensional problem based on the structure of FIG. 4,

FIGS. 7a-c show respectively objectives and constraint boundaries for Cheap, Expensive and KBNN models used to solve problem A of FIG. 5,

FIGS. 8a-c show respectively objectives and constraint boundaries for Cheap, Expensive and KBK models used to solve problem B of FIG. 5, and

FIGS. 9a and b show respectively the finite elements used to generate low and high fidelity models of a gas turbine engine component.

### DETAILED DESCRIPTION

The methods proposed by the present invention are based on techniques which might generally be referred to as response surface modelling using multifidelity optimisation.

It is useful to consider first, therefore, a more conventional approach to multifidelity optimisation, before considering the application of the this technique to the problems that the present invention is aimed at addressing.

Multifidelity Modelling Using Artificial Neural Networks

An artificial neural network (see, for example, White et al. (1992) consists of a set of simple processing units which communicate by sending signals to each other over a large number of weighted connections. The network is trained using training data obtained from selective calls to the high fidelity model. The trained model can then be used as a surrogate to the original expensive code. However, when training data is limited due to the prohibitive cost of generating sufficient learning samples, then such approximations can be inadequate. The use of multifidelity models can help to overcome such problems.

Watson and Gupta (1996) successfully applied neural networks to multifidelity modelling. The basic idea is still to approximate a function fₑ which is expensive to compute so that very few training data are available. However, the approximation is improved by using a cheap function fₐ which approximates fₑ and is less costly to compute but lacks accuracy. This cheaper function contains useful information about the behaviour of fₑ in regions where fₑ is not sampled.

The difference between the two models

d=fₑ−fₐ (1)

is considered. This is sampled at various locations xᵢ, i=1, 2, . . . , N and provides training data (xᵢ, dᵢ), i=1, 2, . . . , N which are used to train the neural network. Thus the N^{th} training datum comprises (i) a vector x_{N} whose components are a plurality of input parameters and (ii) the difference between the expensive and cheaper functions when these functions receive the input parameters. After training, the network provides a cheaper approximation \hat{d} to d throughout the whole domain. As a result,

fₐ+\hat{d}≈fₑ (2)

can be used as a surrogate repetitively at little cost. This is clearly useful when we wish to optimise the expensive model, as we can optimise fₐ+\hat{d} instead of fₑ.

Another approach is to model the ratio r=fₑ/fₐ, and then consider \hat{r}fₐ as a surrogate for fₑ.

Whichever approach is used, the trained network effectively acts as a compensation model which compensates for discrepancies (i.e. d or r) between the expensive function (high fidelity model) and cheap function (low fidelity model).

Furthermore, although we have described the provision of data (xᵢ, dᵢ) and discussed the training of a network to model d, the skilled person would recognise that this is essentially equivalent to providing data (xᵢ, f_{e,i}) and training the network so that fₐ as compensated by the network approximates fₑ.

Multifidelity Modelling Using a Neural Network and a Low Fidelity Model

Model Structure

In one of its aspects the present invention proposes a modified approach in which a low fidelity model which has adjustable weightings for respective model input parameters is used to generate a multifidelity model of the system.

This low fidelity model, fₐ, shares physics with the high fidelity expensive model, fₑ, but differs in details. fₐ defines our prior knowledge about the system being modelled and gives us some information as to the behaviour of fₑ away from expensively sampled points. If there is reasonable correlation between the models, this approach is likely to provide a relatively accurate prediction of system behaviour, particularly at extrapolated points.

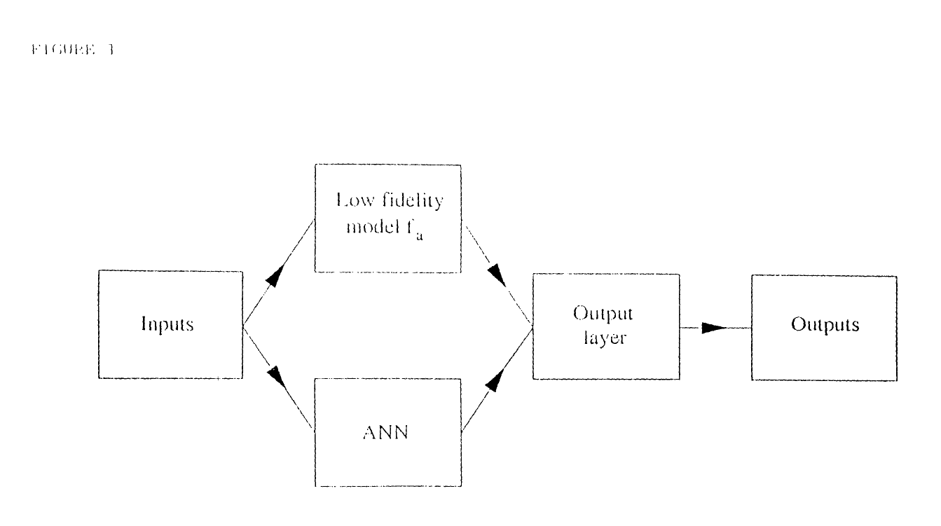

FIG. 1 shows the overall architecture of the multifidelity model.

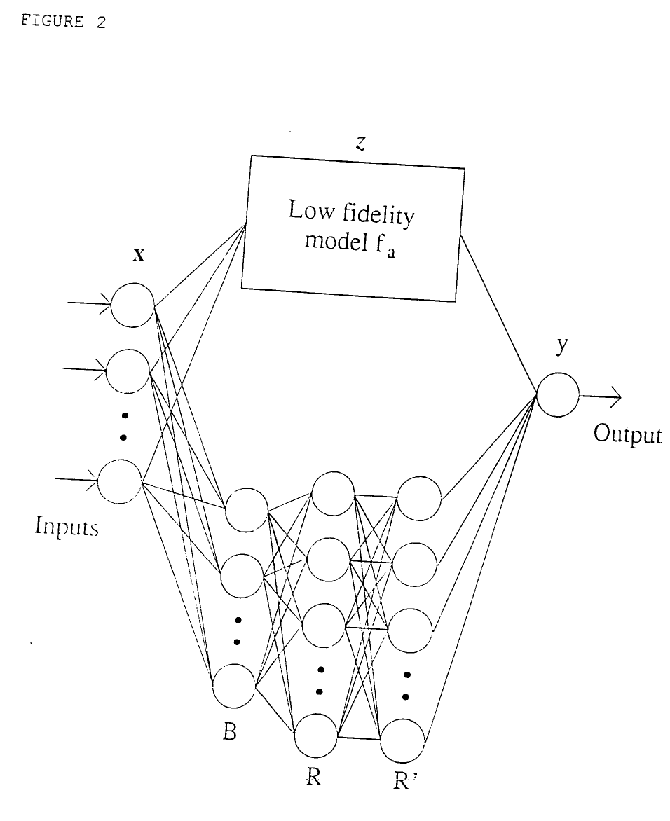

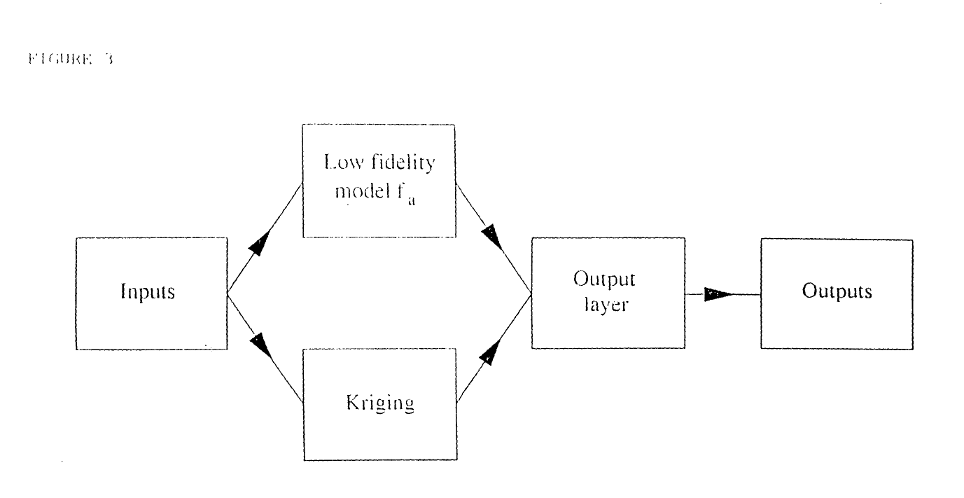

In more detail and with reference to FIG. 2, the multifidelity model comprises a network with input layer X, knowledge layer Z, boundary layer B, region layer R, normalised region layer R′ and output layer Y. The low fidelity model, fₐ, appears in the knowledge layer Z. The outputs of the knowledge layer Z and neural layers R′ are weighted and merged by multiplication. In our experience this seems to perform better than using a multilayer perceptron with a single hidden Layer.

Layers X, B, R, R′ and y effectively form a neural network that serves as a compensation model to compensate for discrepancies between the low fidelity model and a high fidelity model (results from which are used to train the multifidelity model).

The input layer accepts inputs x. Details of the knowledge layer, boundary layer, region layer, normalised region layer and output layer follow in equations (3)-(8). We consider the problem with input vector x (Nₓ×1), output y (approximating the high fidelity model fₑ(x)) and knowledge z (see equation (3)). Both y and z could be vectors, but we will consider the case of a single output only.

The “empirical knowledge” is provided by the cheap (low fidelity) model. The input x is weighted so that the knowledge vector is calculated from the low fidelity model evaluation as

z=fₐ(W₁x+w₂), (3)

where W₁

$${W}_{1} = diag \{ {w}_{1}^{1} , {w}_{2}^{2} , … , {w}_{1}^{{N}_{x}} \}$$

is a diagonal matrix of weights for scaling and w₂ is a vector of weights for a shift of the input arguments. This procedure can easily cope with situations where the cheap and expensive models differ only by a scaling or a shift in the inputs. The weights in (3) are adjustable parameters to be determined when training the network. Since the low fidelity model should be a reasonable approximation to the high fidelity model the matrix W₁ should be close to the identity matrix and w₂ should be close to the zero vector.

In the boundary layer, the neuron i is calculated as

bᵢ=B(x, vᵢ), i=1, . . . , N_{b}. (4)

This layer could also incorporate function knowledge as in Wang and Zhang (1997). However, we take it simply as the inner product of x and vᵢ.

bᵢ=x^{T}vᵢ, i=1, . . . , N_{b}. (5)

where vᵢ are a set of free parameters that will be determined during the training process.

Using a sigmoid function [symbol] . the region layer neurons are constructed from boundary neurons as

$${r}_{i} = {\prod }_{j = 1}^{{N}_{b}} ( {α}_{ij} {b}_{j} + {θ}_{ij} ) , i = 1 , 2 , … , {N}_{r} . \qquad ( 6 )$$

Here αᵢⱼ and θᵢⱼ are respectively scaling and bias parameters (i.e. adjustable weightings).

The normalising layer normalises the outputs of the region layer, that is,

$${r}_{i}^{′} = \frac{{r}_{i}}{{\sum }_{j = 1}^{{N}_{r}} {r}_{j}} , i = 1 , … , {N}_{{r}^{′}} = {N}_{r} . \qquad ( 7 )$$

Finally, the output is given by

$$y = {β}_{1} z ( {\sum }_{k = 1}^{{N}_{r}} {ρ}_{k} {r}_{k}^{′} ) + {β}_{0} . \qquad ( 8 )$$

Note that the merging of the knowledge layer and the neural layer has been performed using multiplication. This is consistent with the approach of Wang and Zhang (1997). Clearly other ways of combining this information (e.g. addition) exist and could be considered. In this way simple relationships between the high and low fidelity models can be exploited. The skilled person would also be able to extend the method to problems with multiple outputs, along the lines of Wang and Zhang (1997).

Training the Model

Let y represent the output from the neural network and the low fidelity model and fₑ represent the high fidelity model output. The neural network and the low fidelity model learn from the training data (xᵢ, fₐ(xᵢ)), i=1, 2, . . . , N_{data}. The trainable parameters are the knowledge weights W₁ and w₂, the boundary layer weights vᵢ, i=1, 2, . . . , N_{b}, the scaling parameters αᵢⱼ and θᵢⱼ, i=1, 2, . . . , Nᵣ, j=1, 2, . . . , N_{b}, β₁, β₀, and ρₖ, k=1, 2, . . . , Nᵣ. For the 2D example described below, this requires a total of 33 parameters to be determined during training, the majority of these deriving from the neural network structure.

The undetermined parameters are chosen to minimize the difference (i.e. optimise the correlation) between the neural network and the low fidelity model outputs y and the actual training outputs fₑ in the least square sense. Thus we minimise

$$E = \frac{1}{2} {\sum }_{i = 1}^{{N}_{data}} {( {y}_{i} - {( {f}_{e} )}_{i} )}^{2} \qquad ( 9 )$$

with respect to these parameters.

The derivatives of E with respect to the unknown parameters are given in Wang and Zhang (1997) and can be used in gradient descent minimisation. Updating the weights in this case requires modifying the traditional backpropagation algorithm (Rumelhart et al. (1986)) slightly to cope with the different network topology. Of course, other optimization strategies such as conjugate gradient minimization (Press et al. (1992)) could be used to determine the weights.

Multifidelity Modelling Using a Kriging Model and a Low Fidelity Model

Model Structure

In another of its aspects the present invention proposes an approach in which a kriging model is used to compensate for discrepancies between high and low fidelity models of the system and thereby to generate a multifidelity model of the system.

The method of the previous section included cheap but low fidelity information along with expensive but high quality information in a neural network framework. We now turn, however, to the problem of replacing the neural network with a kriging model (see Jones et al. (1998) for a detailed description of the kriging method).

In typical approximation methods, the non-linear relationship between observations (responses) and independent variables is expressed as

y=f(x) (10)

where y is the observed response, x is a vector of k independent variables

x=[x₁, x₂, . . . , xₖ] (11)

and f(x) is some unknown function. We define

ŷ=\hat{f}(x), (12)

an approximation for y based on kriging. A brief description of its implementation now follows. We then modify this classical approach to incorporate knowledge that comes from a weighted low fidelity model.

Given a set of N training data [x⁽¹⁾, x⁽²⁾, x^{(N)}] the kriging model can be used to make a prediction ŷ=\hat{f}(x) at untested points x in the design space.

A correlation matrix of the training data

R(x⁽ⁱ⁾, x^{(j)})=exp[−d(x⁽ⁱ⁾, x(j))] (13)

is first sought where d is some distance measure. For example

$$d ( {x}^{( i )} , {x}^{( j )} ) = {\sum }_{h = i}^{k} {θ}_{h} {\vert {x}_{h}^{( i )} - {x}_{h}^{( j )} \vert}^{{p}_{h}} ( {θ}_{h} \geq 0 , 1 \leq {p}_{h} \leq 2 ) \qquad ( 14 )$$

where θₕ and pₕ are some as yet undetermined parameters.

When we wish to sample at a new point x, we form a vector of correlations between the new points and the training data

r(x)=R(x, x⁽ⁱ⁾)=[R(x, x⁽¹⁾), . . . , R(x, x^{(N)})]. (15)

The prediction is then given by

ŷ(x)=μ+r^{T}R⁻¹(y−1μ). (16)

The mean and variance of the prediction are

$$μ = \frac{{1}^{T} {R}^{- 1} y}{{1}^{T} {R}^{- 1} 1} \qquad ( 17 )$$

and

$${σ}^{2} = \frac{{( y - 1 μ )}^{T} {R}^{- 1} ( y - 1 μ )}{N} \qquad ( 18 )$$

respectively.

The parameters θₕ and pₕ are determined by maximising the likelihood

$$\frac{1}{{( 2 π )}^{N / 2} {( {σ}^{2} )}^{N / 2} {\vert R \vert}^{1 / 2}} exp [ \frac{- {( y - 1 μ )}^{T} {R}^{- 1} ( y - 1 μ )}{2 {σ}^{2}} ] \qquad ( 19 )$$

of the sample.

Our multifidelity modelling strategy using kriging again models the difference or the ratio of the high and low fidelity models at a given set of samples points. That is, we may approximate

d=fₑ−fₐ (20)

and add it to fₐ to approximate fₑ. Alternatively we may model

r=fₑ/fₐ (21)

and then take \hat{r}fₐ as a surrogate for fₑ.

Furthermore, however, we use low fidelity cheap information along with the high quality expensive information within the approximating model itself. The cheap model, taken as prior knowledge, can be suitably weighted (as discussed above) to ensure best agreement between the two models of differing fidelity. The general structure of information flow is shown in FIG. 3. Note the similarity in the approach of the strategy of FIG. 1 and that of FIG. 3. The only significant departure is in the way parameters are extracted in the two cases—while the algorithm underlying the diagram in FIG. 1 uses an artificial neural network technique, that of FIG. 3 uses kriging. Thus in both cases the low fidelity model is an integral part of the approximation which has in parallel a compensation model which is either a neural network or a kriging model. This is in contrast to standard correction techniques where the low fidelity data do not inherently control the model training process. In mathematical terms, such standard techniques lack implicit influence over the likelihood function that needs to be maximized.

Training the Model

In the present discussion, we consider modelling a response with a single output. The inputs x are fed into the knowledge layer (of the weighted low fidelity model) and into the kriging model. As shown in FIG. 3, the knowledge layer outputs the value z, using the weighted low fidelity method according to equation (3). The kriging model inputs x and outputs some prediction, K. The output of the model can be defined in several ways e.g., based on addition Z+K or multiplication Z X K. These could also be weighted as in equation (8). In the examples that follow, we use multiplication. It may also be possible to let the model itself decide on the best functional form between the outputs of the knowledge layer z and the kriging prediction K by using further parameters.

Referring to the neural network-based multifidelity model of FIG. 1, the undetermined weights were extracted by minimizing the sum of squares of differences (see equation (9)). However, this approach is not viable with a kriging model. This is because kriging models interpolate data exactly, thus the difference between the data and the model is zero for all the sampled points, whatever our choice of weights. Therefore, the free parameters of the model (including the weights in the low fidelity model) need to be determined by maximizing the likelihood function of the sample as given by equation (19). This ensures that the best model out of all possible interpolating models is chosen. We have set pₕ=2 and optimised with respect to θₕ, h=1, . . . , k and the weights in the knowledge layer. This typically results in a reduced optimisation problem compared to the training of the neural network-based multifidelity model. For the 2D example discussed in the following section, this requires just a six dimensional optimisation problem (compared with 33 for the neural network-based multifidelity model). Thus significant reductions in computational overheads can be achieved by adopting a kriging approach. Once again, the optimisation problem can be tackled using standard techniques, for example, conjugate gradients.

### EXAMPLE 1

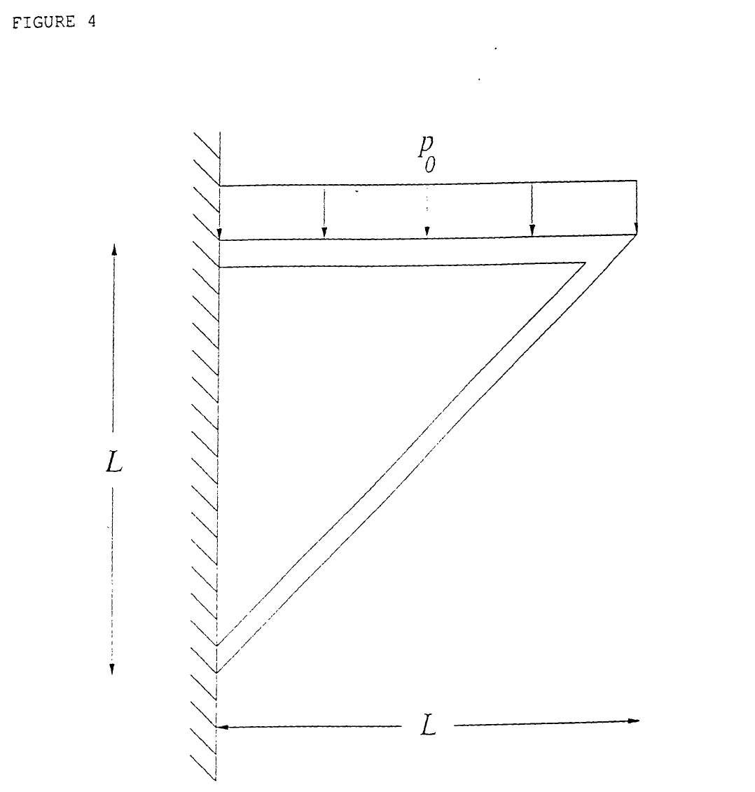

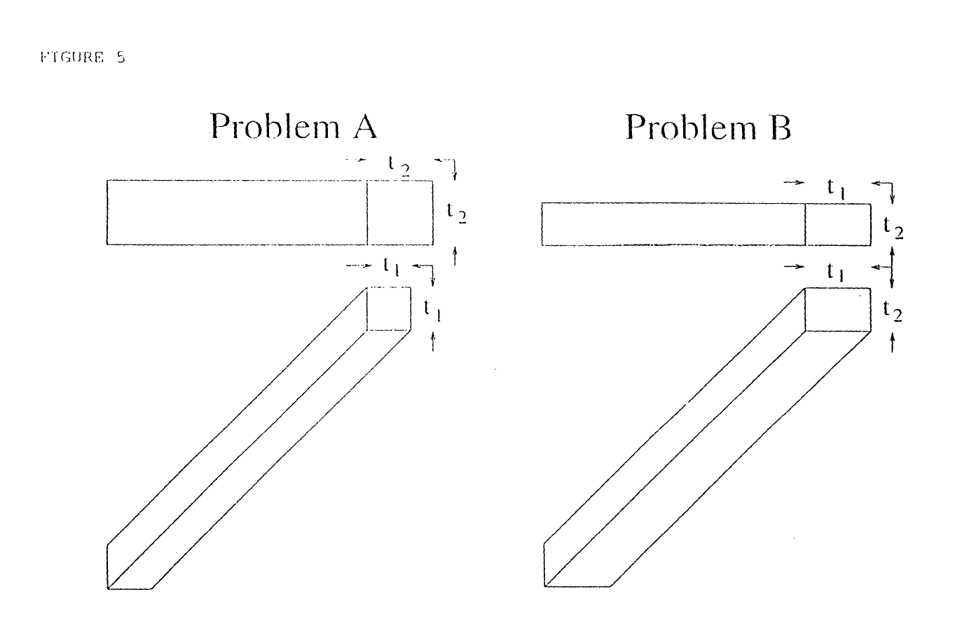

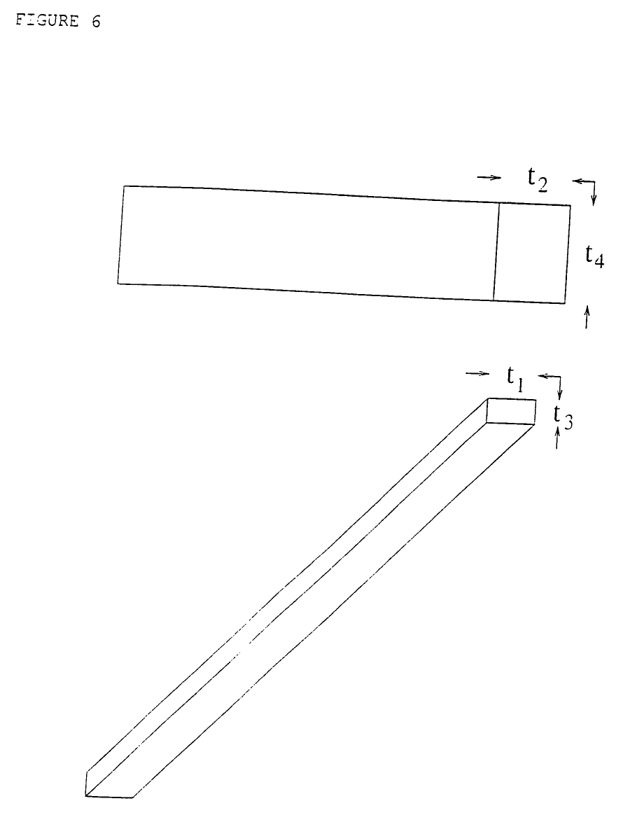

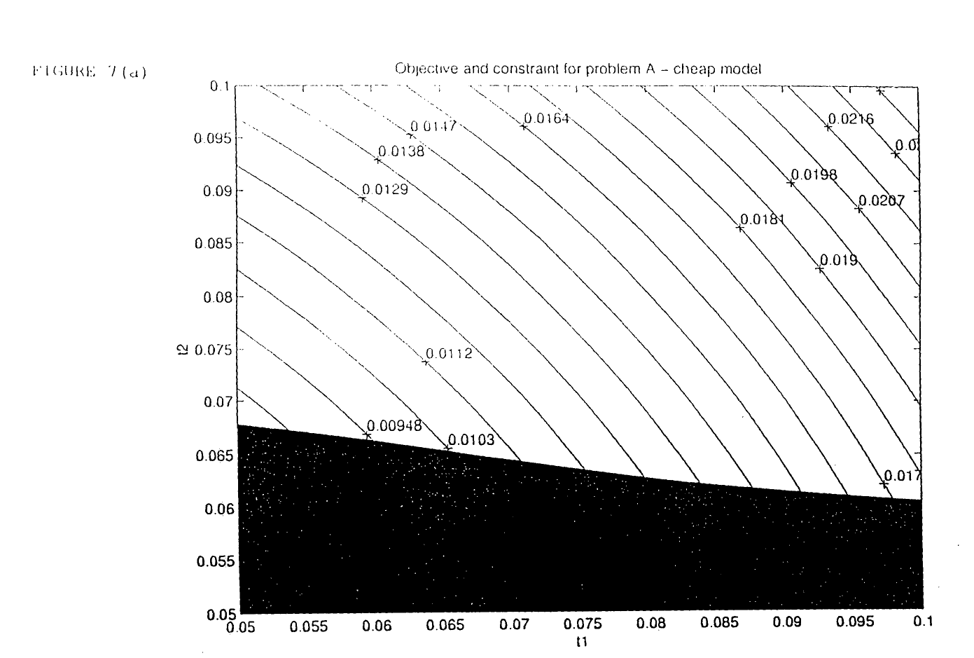

Consider the elastic structure as shown in FIG. 4. In this example we consider the length L to be 1 metre. The horizontal beam is subjected to a uniformly distributed load p₀=50 N/m. We wish to minimize the weight of the structure by varying the cross section in various ways. We initially consider two two-dimensional problems as shown in FIG. 5. In the first two-dimensional problem (Problem A) the two parts of the elastic structure have different square sections, while in the second two-dimensional problem (Problem B) the two parts of the elastic structure have the same rectangular section. We also consider a four-dimensional problem as shown in FIG. 6 in which the two parts of the elastic structure have different rectangular sections. In all cases the minimisation is carried out subject to the constraints

σₘₐₓ<100000 N/m² (22)

where σₘₐₓ is the maximum stress in the structure and

0.05 m≦tᵢ<0.1 m (23)

where i respectively varies from one to two or from one to four for the two and four dimensional problems.

The problem was analysed using a simple FE beam model. Two levels of complexity were considered: a coarse (low fidelity) model fₐ consisting of just 4 elements and a fine (high fidelity) model fₑ consisting of 100 elements. In these two models the objective V (volume is proportional to weight) remains the same whereas the stress, which forms the constraint, varies. It is this variation in stress between fₑ and fₐ that we attempt to model.

2D Beam Problem

Results were obtained from fₑ for nine combinations of t₁ and t₂: (0.05, 0.05), (0.075, 0.05), (0.1, 0.05), (0.05, 0.075), (0.075, 0.075), (0.1, 0.075), (0.05, 0.1), (0.075, 0.1), (0.1, 0.1). This provided a set of training data containing nine sampled points in design space.

The following seven approaches (referred to hereafter by the shortened terms in brackets) were used to solve this and subsequent problems:

(i) Low fidelity model optimisation (Cheap)

(ii) Kriging the expensive data at the sampled points and optimising (Kriging)

(iii) Kriging the difference fₑ−fₐ at the sampled points adding this to fₐ and optimising (Addition)

(iv) Kriging the ratio fₑ/fₐ at the sampled points multiplying this by fₐ and optimising (Ratio)

(v) Multifidelity modelling using a neural network and the weighted low fidelity model (KBNN—Knowledge-Based Neural Network approach).

(vi) Multifidelity modelling using a kriging model and the weighted low fidelity model (KBK—Knowledge-Based Kriging approach)

(vii) Direct optimization of the high fidelity model (Expensive)

Approaches (iii), (iv) and (vi) are in accordance with the first aspect of the present invention, approaches (v) and (vi) are in accordance with the second aspect of the present invention, and approaches (i), (ii) and (vii) are provided for comparative purposes. It should be noted, however, that in many realistic situations direct optimization of a high fidelity model will not be feasible.

In both the KBNN and the KBK models we consider the elements of W₁ in the range [0.75, 1.10] and those of w₂ in the range [−0.025, 0.025]. In the KBNN neural network we take N_{b}=Nᵣ=N_{r′}=3. The results for problem A are shown in Table I. Table I also lists the relative error (stress) in each model. This is an average error taken over 441 test points spread throughout the design space. The error was computed by taking results of the high fidelity model as exact. Table II lists the same results as Table I, but for problem B.

TABLE I

| | | | | Relative |
|---|---|---|---|---|
| Model | t₁ | t₂ | V | error |
| Cheap | 5 × 10⁻² | 6.7846 × 10⁻² | 8.139 × 10⁻³ | 1.837 × 10⁻¹ |
| Kriging | 5 × 10⁻² | 7.3944 × 10⁻² | 9.003 × 10⁻³ | 9.267 × 10⁻² |
| Addition | 5 × 10⁻² | 7.2780 × 10⁻² | 8.832 × 10⁻³ | 2.418 × 10⁻² |
| Ratio | 5 × 10⁻² | 7.2645 × 10⁻² | 8.813 × 10⁻³ | 2.262 × 10⁻³ |
| KBNN | 5 × 10⁻² | 7.2576 × 10⁻² | 8.803 × 10⁻³ | 2.8160 × 10⁻⁴ |
| KBK | 5 × 10⁻² | 7.2576 × 10⁻² | 8.803 × 10⁻³ | 1.723 × 10⁻³ |
| Expensive | 5 × 10⁻² | 7.2571 × 10⁻² | 8.802 × 10⁻³ | N/A |

TABLE II

| | | | | Relative |
|---|---|---|---|---|
| Model | t₁ | t₂ | V | error |
| Cheap | 5 × 10⁻² | 7.5101 × 10⁻² | 9.066 × 10⁻³ | 1.811 × 10⁻¹ |
| Kriging | 5 × 10⁻² | 8.4340 × 10⁻² | 1.0181 × 10⁻² | 6.736 × 10⁻² |
| Addition | 5 × 10⁻² | 8.3597 × 10⁻² | 1.0091 × 10⁻² | 1.281 × 10⁻² |
| Ratio | 5 × 10⁻² | 8.3376 × 10⁻² | 1.0064 × 10⁻² | 6.663 × 10⁻⁵ |
| KBNN | 5 × 10⁻² | 8.3380 × 10⁻² | 1.0065 × 10⁻² | 8.7170 × 10⁻⁶ |
| KBK | 5 × 10⁻² | 8.3379 × 10⁻² | 1.0065 × 10⁻² | 1.5740 × 10⁻⁵ |
| Expensive | 5 × 10⁻² | 8.3379 × 10⁻² | 1.0065 × 10⁻² | N/A |

It is clear from these tables that modelling using the nine high fidelity model response points alone (Cheap, Kriging) leads to relatively large errors.

Introducing knowledge in the form of a cheap approximation (Addition, Ratio) is beneficial as there is some degree of correlation between the models. We should expect this since the two models represent the same physical system. In the example, the Addition model performs worse than the Ratio model, but how these models perform relative to each other is highly problem dependent.

The knowledge-based approaches using a weighted low fidelity model (KBNN, KBK) perform better. As the methods provide more flexibility than modelling the difference and ratio alone, they are expected to outperform the Addition and Ratio models. For a given system it is not clear which of the KBNN and KBK approaches is likely to perform best, although the kriging-based approach is generally quicker to set up.

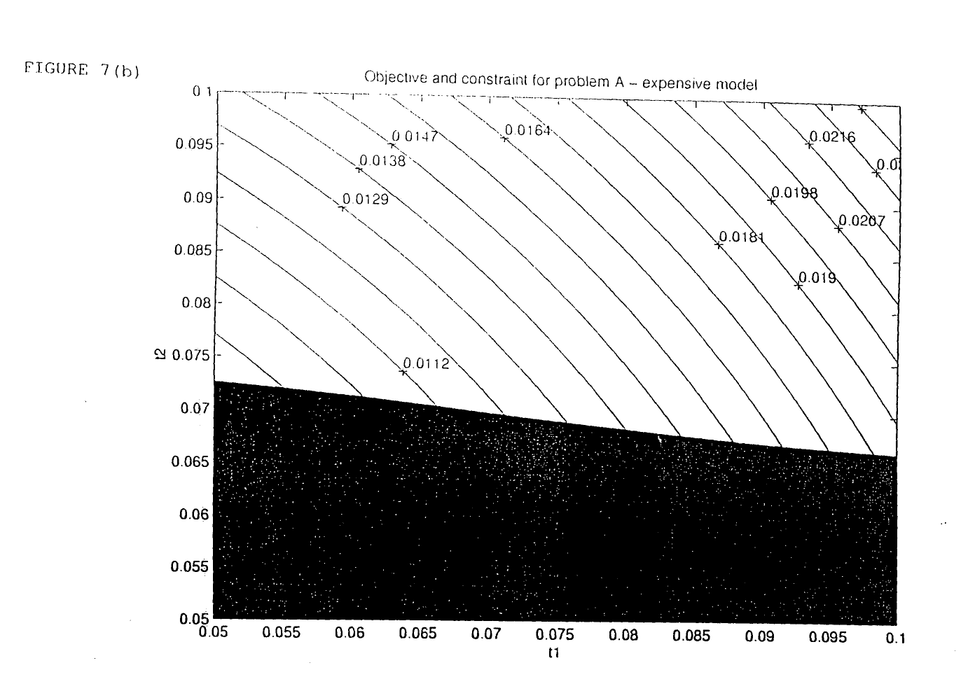

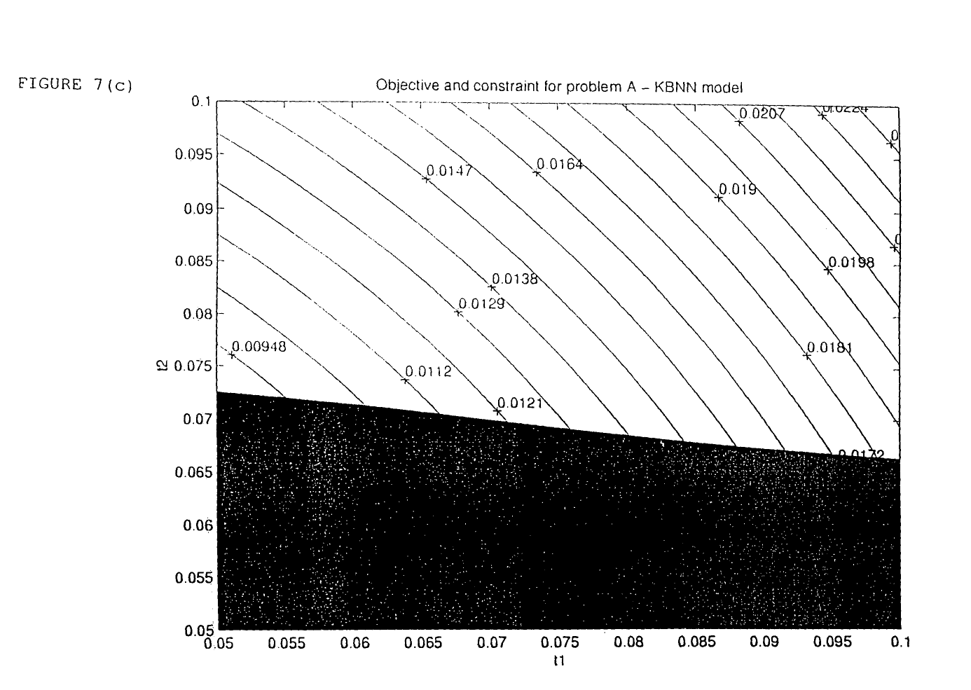

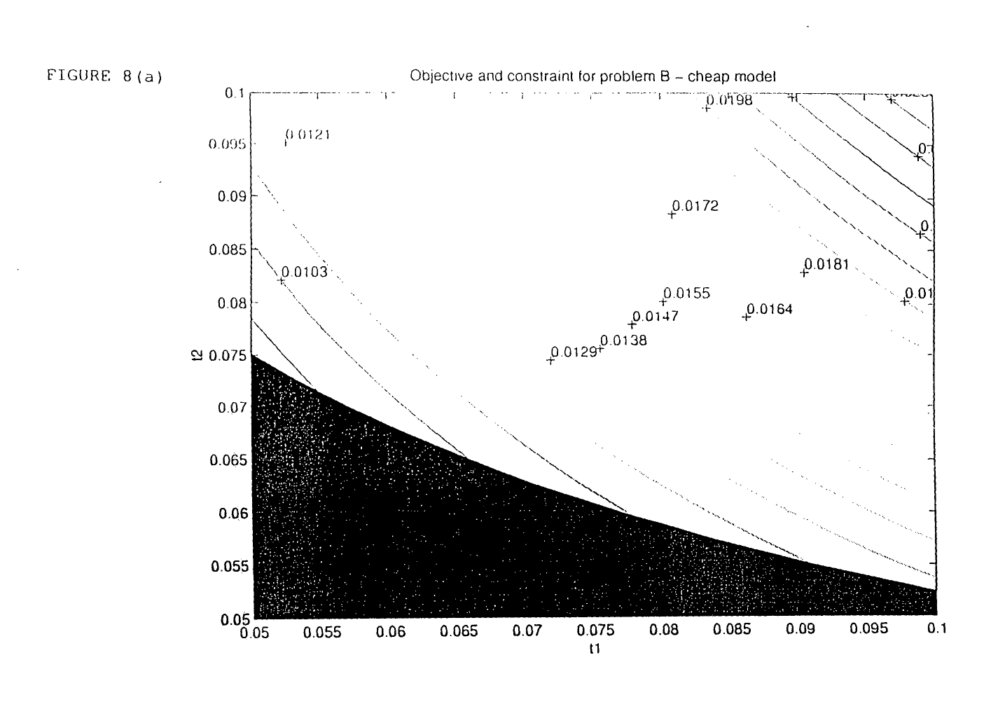

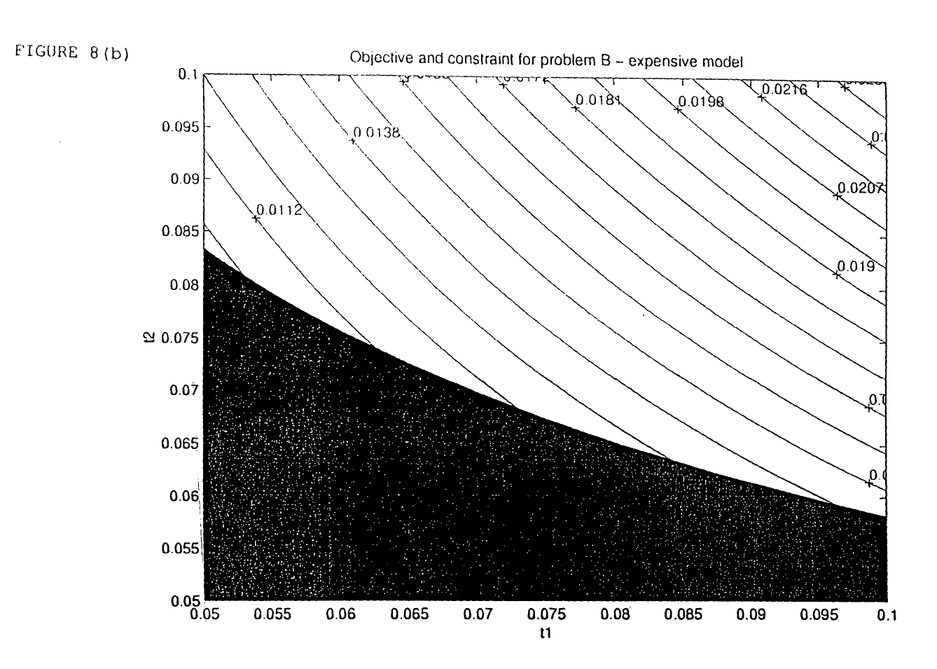

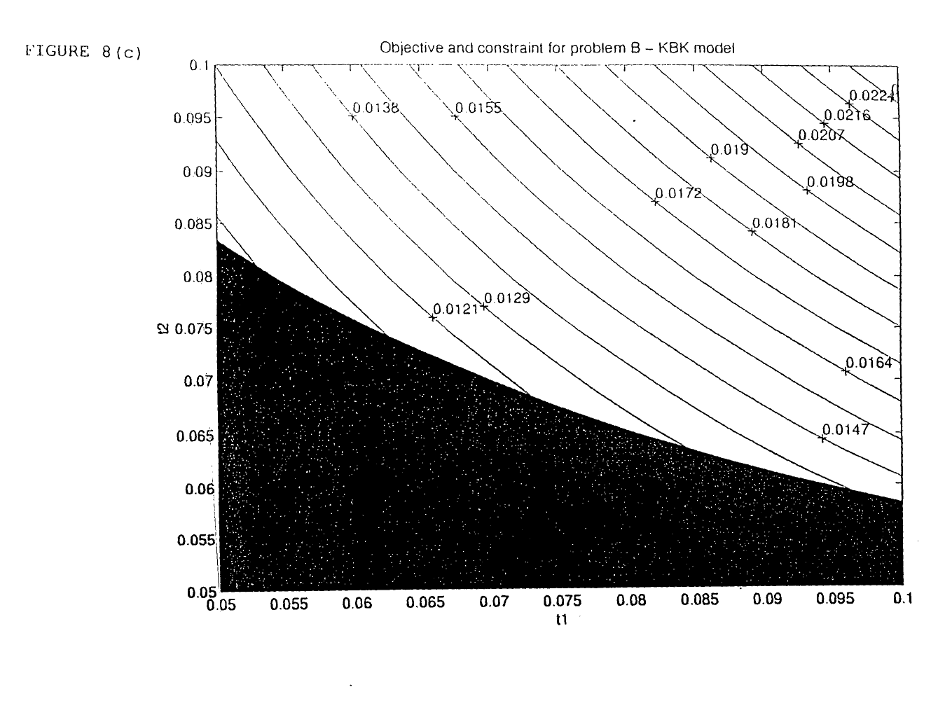

FIGS. 7a-c show respectively the objectives and constraint boundaries for the Cheap, Expensive and KBNN models for problem A. Similarly, FIGS. 8a-c show respectively plots of the objectives and constraint boundaries for the Cheap, Expensive and KBK models for problem B.

Each of FIGS. 7a-c and FIGS. 8a-c have t₁ and t₂ respectively plotted along the horizontal and vertical axes and show contours of equal structural weight. Clearly the structural weight decreases as t₁ and t₂ are reduced. The areas shaded in black correspond to infeasible designs (i.e. values of t₁ and t₂ for which the resulting stress is greater than the maximum allowable stress).

The Expensive high fidelity models (FIGS. 7b and 8b) produce the most accurate results, and the better the lower cost model, the more closely it should replicate the shaded areas of FIGS. 7b and 8b. Comparing FIG. 7a with FIG. 7b and FIG. 8a with FIG. 8b, the Cheap low fidelity models do not reproduce well the shaded areas. In contrast, comparing FIG. 7c with FIG. 7b and FIG. 8c with FIG. 8b, the shaded areas produced by the KBNN multifidelity model for problem A and the KBK multifidelity model for problem B are almost indistinguishable from those produced by the corresponding Expensive models. Thus the multifidelity models produce an accurate representation of the high fidelity models, but at considerably reduced computational cost.

4D Beam Problem

Turning to the 4D beam problem, the four parameters of the design space are the cross sectional properties of each beam. As training data we used 21 points obtained from the high fidelity model. These points representatively sampled design space. Solutions to the problem were sought using the Cheap, KBNN, KBK and Expensive models only. The results are shown in Table III. It should be noted that the high fidelity model optimisation required 185 expensive function evaluations using the L-BFGS-B optimizer of Zhu et al. (1994) to optimize the problem in this way compared to just 21 evaluations using the KBNN and KBK approaches of the present invention.

TABLE III

| Model | t₁ | t₂ | t₃ | t₄ | V |
|---|---|---|---|---|---|
| Cheap | 5 × 10⁻² | 5 × 10⁻² | 5 × 10⁻² | 7.9943 × | 7.5327 × |
| | | | | 10⁻² | 10⁻³ |
| KBNN | 5 × 10⁻² | 5 × 10⁻² | 5 × 10⁻² | 8.8470 × | 7.9590 × |
| | | | | 10⁻² | 10⁻³ |
| KBK | 5 × 10⁻² | 5 × 10⁻² | 5 × 10⁻² | 8.8576 × | 7.9643 × |
| | | | | 10⁻² | 10⁻³ |
| Expensive | 5 × 10⁻² | 5 × 10⁻² | 5 × 10⁻² | 8.8427 × | 7.9569 × |
| | | | | 10⁻² | 10⁻³ |

The KBNN and KBK approaches again performed well: including information from the low fidelity model led to predictions of the optimum which were very close to the true optimum in both cases.

### EXAMPLE 2

Next we consider the design of a tail bearing housing for an aero gas turbine engine. Again the objective is to minimize the weight of the structure whilst keeping the stress at a key point below a prescribed value of 2.0 N/mm².

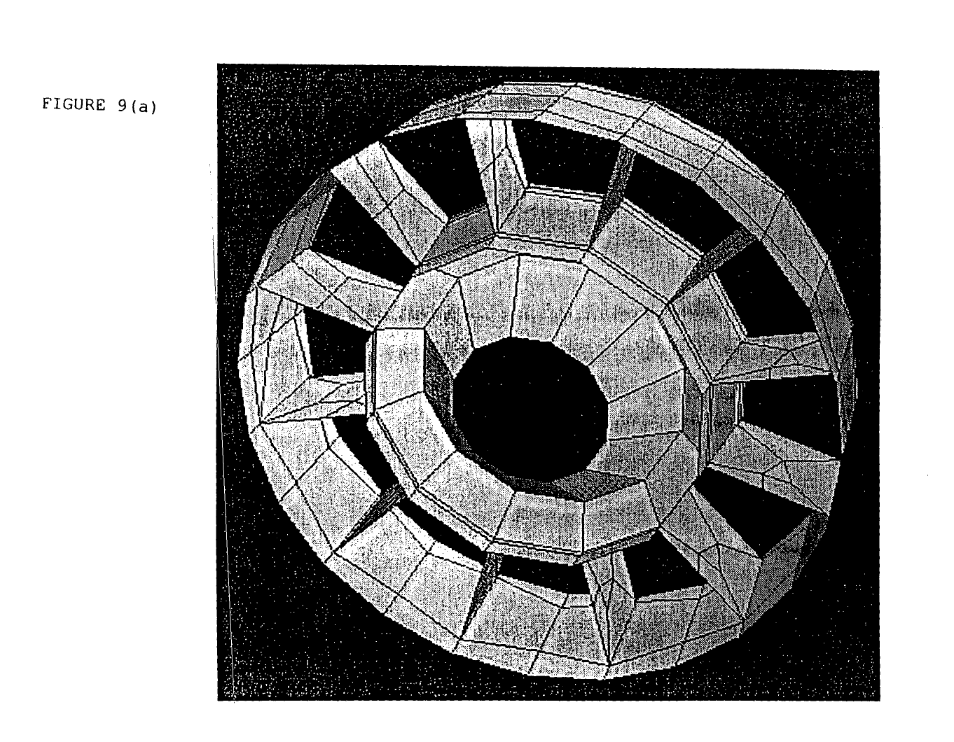

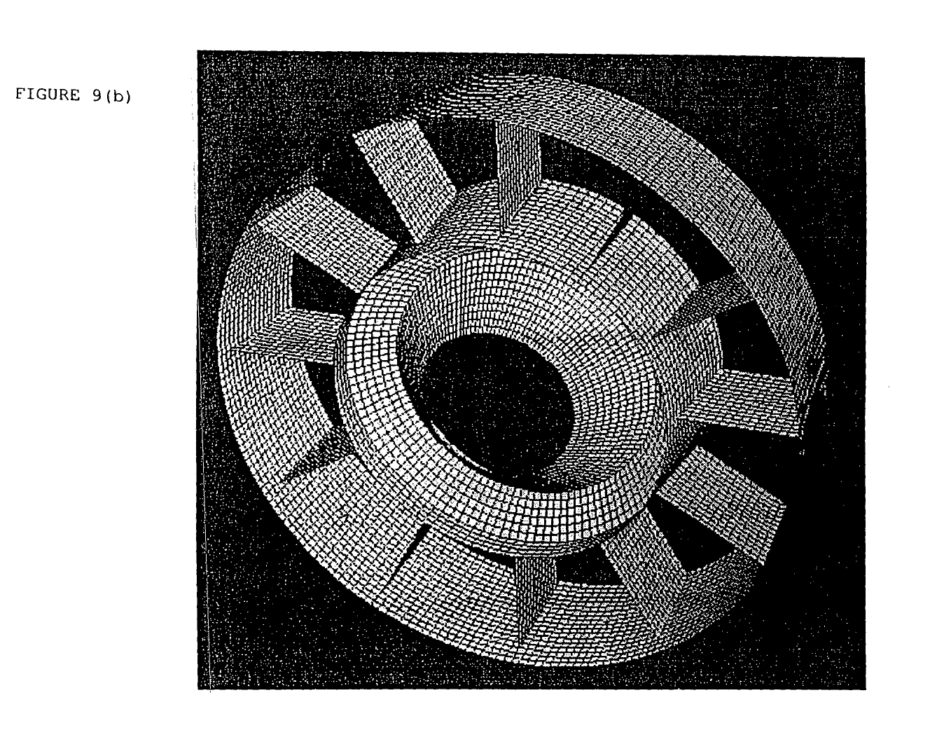

The low fidelity model is shown in FIG. 9a. This model consists of 246 finite elements and requires solution of a system of 1470 equations. A much more sophisticated high fidelity model is shown in FIG. 9b. This model consists of 11640 elements and requires solution of a system of 71064 equations. The low fidelity model, which should be much quicker to solve than the high fidelity model, can be used as a guide to the behaviour of the high fidelity model. One might expect a well tuned solver dealing with banded matrices to scale with perhaps O(N²), which this would give a ratio of run times of over 2000. However, because the models are, in absolute terms, both quite small, the savings are less because of the overheads associated with commercial finite element codes. We saw a ratio closer to 20.

In the following work an extremely accurate surrogate of the low fidelity model was used in the knowledge layer. The surrogate was built using a standard kriging model but with a relatively large set of training data (500 evaluations for 4 variables). The reason we used an accurate surrogate is twofold. Firstly we could then avoid software integration problems associated with linking our fortran code to the finite element solver. Secondly, it led to faster training times, because although the low fidelity model should be computationally much cheaper than the high fidelity model, due to the overheads involved with a commercial finite element code the difference proved not so great in practice. By utilising an accurate surrogate in place of the low fidelity model we avoided this overhead during training of the knowledge based models (where the weighted low fidelity model implicitly influences the training procedure).

Four design variables define the structural geometry, and these were constrained within the following realistic bounds:

1 mm≦x₁≦4 mm

2 mm≦x₂≦5 mm

2 mm≦x₃≦5 mm

2 mm≦x₄≦5 mm. (24)

The variables xᵢ to x₄ respectively relate to the thickness of the inner ring faces, inner ring thickness, outer ring thickness and spoke thickness.

Initially 16 runs of the high fidelity model were made. Each run produced a point in design space comprising a set of the input parameters and the minimum weight and stress associated with these parameters. The points were chosen in order representatively to sample design space and were used for model training.

Cheap, Kriging, Ratio, KBNN, KBK models were then used to model the component. For the purposes of assessing the models' accuracies, 484 further high fidelity (Expensive) model evaluations at alternative combinations of the input parameters were made (but not used in model training). The results of the models were then compared with these evaluations. Table IV compares the results of the modelling.

TABLE IV

| | Average | |
|---|---|---|
| Model | error | % |
| Cheap | 46.4919 | |
| Kriging | 2.4074 | |
| Ratio | 1.7040 | |
| KBNN (3) | 3.2215 | |
| KBNN (5) | 3.8932 | |
| KBK | 1.4251 | |

There was reasonably good correlation between the resulting stresses in the Expensive and Cheap models. However, the average error in minimum weight calculated by the Cheap model at the 484 additional points was large. The Kriging model led to a much reduced average error, and the Ratio model reduced the average error still further. However the KBK model led to the lowest error of all.

Training the KBNN proved to be difficult in this example: we tried training a KBNN with 3 neurons per layer (KBNN(3)—43 optimisation variables) as well as a KBNN with 5 neurons per layer (KBNN(5)—85 optimisation variables). In both cases we were unable fully to train the model, leading to generally poor results. This highlights the potential difficulties with the KBNN approach. In general relatively large amounts of (expensive) training data are required. It might also be that more neurons are required before an acceptable approximation can be obtained, but this would involve solving an even larger optimisation problem during training.

For both the KBK and KBN models the elements of W₁ were chosen in the range [0.75, 1.10] and those of w₂ in the range [−0.25, 0.25].

The optimum design produced by the most accurate model (KBK) weighed 73.31 kg. The optimum design variables x₁ to x₄ were (2.0233, 2.0, 2.0, 2.0 mm) and the stress took the value 2.013 N/mm², which is very close to our predefined maximum value of 2.0 N/mm².

A direct optimization was then performed using the Expensive model. The resulting optimum design had a weight of 73.58 kg. The optimum design variables were (2.0547, 2.0, 2.0, 2.0 mm) and the stress value was 1.972 N/mm². This required a total of 158 calls to the high fidelity model. Thus the KBK approach led to a good approximation of the optimum design but with a significant reduction in computational cost.

Thus the examples show that multifidelity knowledge-based modelling approaches according to the present invention are more effective than standard response surface approaches built on expensive models alone. This is because the multifidelity models can provide good approximations with relatively little training data and can provide relatively accurate extrapolations.

Furthermore, the multifidelity modelling provided improved accuracy on a global scale compared to the other methods described. Clearly Example 1 is somewhat simple, but does provide a benchmark result for comparing the various approaches. Example 2 demonstrates the approach on a more realistic problem.

While the invention has been described in conjunction with the exemplary embodiments described above, many equivalent modifications and variations will be apparent to those skilled in the art when given this disclosure. Accordingly, the exemplary embodiments of the invention set forth above are considered to be illustrative and not limiting. Various changes to the described embodiments may be made without departing from the spirit and scope of the invention.

### REFERENCES

The references listed below are hereby incorporated by reference.

Chang, K. J., Haftka, R. T., Giles, G. L. and Kao, P. -J., Sensitivity-based scaling for approximating structural response, Journal of Aircraft, 30:283-287, 1993.

Haftka, R. T., Combining global and local approximations, AIAA Journal, 29:1523-1525, 1991.

Hutchinson, M. G., Unger, E. R., Mason, W. H., Grossman, B. and Haftka, R. T., Variable-complexity aerodynamic optimization of a high speed civil transport wing, Journal of Aircraft, 31:110-116, 1994.

Jones, D. R., Schonlau, M. and Welch, W. J., Efficient global optimization of expensive black-box functions, Journal of Global Optimization, 13:455-492, 1998.

Myers, R. H. and Montgomery, D. C., Response surface methodology: Process and product optimization using designed experiments, John Wiley and Sons Inc, 1995.

Press, W. H., Teukolsky, S. A., Vellering, W. T. and Flannery, B. P., Numerical recipes in fortran, 2nd Edition, Cambridge University Press, 1992.

Rumelhart, D. E., Hinton, G. E. and Williams, R. J., Learning representations by backpropagating errors, Nature, 323:533-536, 1986.

Vitali, R., Haftka, R. T. and Sankar, B. V., Multifidelity design of a stiffened composite panel with a crack, 4th World Congress of Structural and Multidisciplinary Optimization, Buffalo, N.Y., 1999.

Wang, F. and Zhang, Q., Knowledge-based neural models for microwave design, IEEE Transactions on Microwave Theory and Techniques, 45:2333-2343, 1997.

Watson, P. M. and Gupta, K. C., EM-ANN models for microstrip vias and interconnects in data-set circuits, IEEE Transactions on Microwave Theory mid Techniques, 44:2495-2503, 1996.

White, H., Gallant, A. R., Kornik, K., Stinchcombe, M. and Wooldridge, J., Artificial neural networks: Approximation and learning theory, Blackwell publishers, 1992.

Zhu, C., Byrd R. H., Lu P. and Nocedal J., L-BFGS-B: a Limited memory FORTRAN code for solving bound constrained optimization problems, Tech. Report, NAM-11, EECS Department, Northwestern University, 1994.

We claim:

1. A method of generating a multifidelity model of a system, comprising the steps of:
(a) obtaining training data from a high fidelity model of the system;
(b) providing a low fidelity model of the system, the low fidelity model having adjustable weightings for respective input parameters to the low fidelity model;
(c) providing a compensation model to compensate for discrepancies between the high and low fidelity models;
(d) adjusting the compensation model and the weightings to optimise the correlation of the low fidelity model, when compensated by the compensation model, with said training data; and
(e) generating a multifidelity model of the system based on the adjusted low fidelity model when compensated by the adjusted compensation model.

2. A method of generating a multifidelity model according to claim 1, wherein the compensation model is a kriging model.

3. A method of generating a multifidelity model according to claim 1, wherein the compensation model is a neural network.

4. A method of generating a multifidelity model according to claim 1, wherein the system comprises a gas turbine engine or a part of a gas turbine engine.

5. A method of generating a multifidelity model according to claim 4, wherein the part of the gas turbine engine comprises a bearing housing.

6. A method of generating a nultifidelity model according to claim 1, wherein the model is selected from the group comprising stress, strain, fluid flow and thermal.

7. Computer readable program code for implementing the method of claim 1.

8. Computer readable media carrying program code for implementing the method of claim 1.

9. A computer system operatively configured to implement the method of claim 1.

10. Computer readable program code for implementing a multifidelity model generated using the method of claim 1.

11. A method of generating a multifidelity model of a system, comprising the steps of:
(a) obtaining training data from a high fidelity model of the system;
(b) providing a low fidelity model of the system;
(c) providing a kriging model to compensate for discrepancies between the high and low fidelity models;
(d) adjusting the kriging model to maximise the likelihood of said training data when the low fidelity model, compensated by the kriging model, is used to model the system; and
(e) generating a multifidelity model of the system based on the low fidelity model when compensated by the adjusted kriging model.
